(19) United States
(12) Patent Application Publication
(10) Pub. No.: US 2020/0199317 A1
(43) Pub. Date: Jun. 25, 2020

(54) METHOD FOR PRODUCING FILM

(71) Applicant: FUJIFILM Corporation, Tokyo (JP)

(72) Inventors: Yohei HAMACHI, Kanagawa (JP); Tamotsu SAIKAWA, Kanagawa (JP); Satoshi KUNIYASU, Kanagawa (JP); Makoto UCHIMURA, Kanagawa (JP)

(73) Assignee: FUJIFILM Corporation, Tokyo (JP)

(21) Appl. No.: 16/810,103

(22) Filed: Mar. 5, 2020

Related U.S. Application Data
(63) Continuation of application No. PCT/JP2018/032267, filed on Aug. 30, 2018.

(30) Foreign Application Priority Data
Sep. 26, 2017 (JP) 2017-184896

(51) Int. Cl. C08J 7/04; B05D 3/06; B05D 3/02; B05D 7/24

(52) U.S. Cl. CPC C08J 7/0427; B05D 3/067; B05D 3/0209; B05D 7/24; C08J 2433/08; C08J 2433/16; C08J 2435/02; C08J 2433/14; C08J 2367/02

(57) ABSTRACT

Provided is a method for producing a film, including a step A of applying a coating liquid containing a film-forming compound, a polymer, and a solvent onto a support to form a coating film, the polymer being at least one selected from a polymer having a fluoroaliphatic group or a polymer having a siloxane structure, and allowing a solution having the polymer dissolved in methyl ethyl ketone at a solid content of 55% by mass to have a viscosity of 15 mPa·s or more at a liquid temperature of 60° C.; a step B of drying the coating film formed in the step A at a rate at which the coating film shows a mass change of from 0.02 g/m²/s to 0.1 g/m²/s for a time which is twice or more t seconds satisfying a predetermined condition A; and a step C of drying the coating film after the step B at a rate at which the coating film shows a mass change of from 0.02 g/m²/s to 0.2 g/m²/s.

### CROSS-REFERENCE TO RELATED APPLICATIONS

This application is a continuation application of International Application No. PCT/JP2018/032267, filed Aug. 30, 2018, the disclosure of which is incorporated herein by reference in its entirety. Further, this application claims priority from Japanese Patent Application No. 2017-184896, filed Sep. 26, 2017, the disclosures of which is incorporated herein by reference in its entirety.

### BACKGROUND OF THE INVENTION

### 1. Field of the Invention

The present disclosure relates to a method for producing a film.

### 2. Description of the Related Art

A resin material can comprise features such as light weight, excellent processability, low cost, and excellent transparency. Therefore, a utility of the resin material as a glass substitute material has attracted attentions in applications where glass has been mainly used in the related art. Examples of such an application include a surface protection film of an image display device, and a protective film for window glasses of automobiles.

On the other hand, from the viewpoint of scratch resistance, oil repellency, antifouling property, and the like, a film comprising a resin layer such as a hard coat layer and a layer with a low refractive index from a curable composition, into which a fluorine-containing compound having a perfluoroalkyl group and the like, a silicon-containing compound having a siloxane group and the like, or the like has been incorporated has been proposed.

For example, JP2013-210583A describes an antireflection film formed by sequentially laminating a hard coat layer and a layer with a low refractive index formed from a coating liquid for forming a layer with a low refractive index on at least one surface of a transparent substrate, in which the layer with a low refractive index includes a fluorine-containing compound and a silicon-containing compound as a surface control agent.

In addition, JP2016-169295A describes a curable composition containing an ethylenically unsaturated compound, particles having a predetermined average primary particle diameter, and a compound having at least one group selected from a perfluoroalkyl group, a perfluoroalkylene ether group, or a polydimethylsiloxane group; and a hard coat layer formed with the curable composition.

### SUMMARY OF THE INVENTION

Meanwhile, in a case where a film formed from a resin material is applied as a glass substitute material to a surface protection film and the like of an image display device, high surface smoothness which is comparable with that of glass is required in some cases due to requirements in terms of appearance.

However, a method for producing a film having surface smoothness which is comparable to that of glass, using a resin material, has not yet been provided.

The technology described in JP2013-210583A or JP2016-169295A is also applicable to formation of a resin layer (a hard coat layer, a layer with a low refractive index, and the like) of a film comprised in an image display device, but the technology does not focus on the surface smoothness of a film.

An object of one embodiment of the present invention is to provide a method for producing a film having excellent surface smoothness which is equal to or higher than that of a glass.

Specific means for accomplishing the object includes the following aspects.

<1> A method for producing a film, comprising:

a step A of applying a coating liquid containing a film-forming compound, a polymer, and a solvent onto a support to form a coating film, the polymer being at least one selected from a polymer having a fluoroaliphatic group or a polymer having a siloxane structure, and allowing a solution having the polymer dissolved in methyl ethyl ketone at a solid content of 55% by mass to have a viscosity of 15 mPa·s or more at a liquid temperature of 60° C.;

a step B of drying the coating film formed in the step A at a rate at which the coating film shows a mass change of from 0.02 g/m²/s to 0.1 g/m²/s for a time which is twice or more t seconds satisfying a condition A shown below; and

a step C of drying the coating film after the step B at a rate at which the coating film shows a mass change of from 0.02 g/m²/s to 0.2 g/m²/s:

Condition A: In a case of measuring a dynamic surface tension of the coating liquid at a liquid temperature of 25° C. by a maximum bubble pressure method, γ2/γ1≤1.05 is satisfied, in which a dynamic surface tension at a bubble lifetime of 5 seconds is defined as γ1 and a dynamic surface tension at a bubble lifetime of t seconds which is shorter than 5 seconds is defined as γ2.

<2> The method for producing a film as described in <1>,

in which the coating liquid has a concentration of the solid contents of 60% by mass or more.

<3> The method for producing a film as described in <1> or <2>,

in which the step A is a step of applying the coating liquid onto the support such that a film thickness of the coating film becomes 25 μm or more.

<4> The method for producing a film as described in any one of <1> to <3>, in which a value obtained by subtracting a surface tension shown in a case of adjusting a concentration of the solid contents of the coating liquid to 60% by mass from a surface tension shown in a case of adjusting the concentration of the solid contents of the coating liquid to 90% by mass is 1 mN/m or less.

<5> The method for producing a film as described in any one of <1> to <4>, in which the polymer allows a solution having the polymer dissolved in methyl ethyl ketone at a solid content of 55% by mass to have a viscosity from 25 mPa·s to 50 mPa·s at a liquid temperature of 60° C.

<6> The method for producing a film as described in any one of <1> to <5>, in which the support is a continuous support.

<7> The method for producing a film as described in any one of <1> to <6>, in which the polymer includes a polymer having a fluoroaliphatic group.

<8> The method for producing a film as described in any one of <1> to <7>, in which the coating liquid contains a polymerizable compound as the film-forming compound and a polymerization initiator.

<9> The method for producing a film as described in <8>, further comprising a step D of irradiating the coating film after the step C with actinic energy rays.

According to an embodiment of the present invention, it is possible to provide a method for producing a film having excellent surface smoothness which is equal to or higher than that of a glass.

### DESCRIPTION OF THE PREFERRED EMBODIMENTS

Hereinafter, the method for producing a film of the present disclosure will be described. It should be noted that the method for producing a film of the present disclosure is not limited to embodiments shown below, and modifications can be made as appropriate within a scope of the purpose of the present disclosure.

In the present disclosure, a numerical value range expressed using “to” means a range that includes the preceding and succeeding numerical values of “to” as the lower limit value and the upper limit value, respectively.

In a numerical value range described stepwise in the present disclosure, the upper limit value or the lower limit value described in a predetermined numerical value range may be converted to the upper limit value or the lower limit value in a numerical value range in another stepwise description. In addition, in the numerical value range described in the present disclosure, the upper limit value or the lower limit value described in a predetermined numerical value range may be converted to a value shown in Examples.

In the present disclosure, in a case where a plurality of substances corresponding to each of the components in a composition are present, the amount of each of components in the composition means a total amount of the plurality of substances present in the composition unless otherwise specified.

In the present disclosure, a term “step” not only means an independent step but also encompasses a step which cannot be clearly distinguished from other steps as long as it enables accomplishment of a predetermined purpose of the step.

In the present disclosure, examples of “actinic energy rays” include actinic energy rays of X-rays, electron beams, ultraviolet rays, visible light, and infrared rays.

In the present disclosure, “(meth)acrylic acid” is in a concept encompassing both of acrylic acid or methacrylic acid, “(meth)acrylate” is in a concept encompassing both of acrylate and methacrylate, and a “(meth)acryloyl group” is in a concept encompassing both of an acryloyl group and a methacryloyl group.

In the present disclosure, a combination of two or more of preferred aspects is a more preferred aspect.

The method for producing a film of the present disclosure (hereinafter also referred to as “the production method of the present disclosure”) is a method for producing a film, having a step A of applying a coating liquid containing a film-forming compound, a polymer, and a solvent onto a support to form a coating film, the polymer being at least one selected from a polymer having a fluoroaliphatic group or a polymer having a siloxane structure, and allowing a solution having the polymer dissolved in methyl ethyl ketone at a solid content of 55% by mass to have a viscosity of 15 mPa·s or more at a liquid temperature of 60° C. (hereinafter also referred to as a “specific polymer”); a step B of drying the coating film formed in the step A at a rate at which the coating film shows a mass change of from 0.02 g/m²/s to 0.1 g/m²/s for a time which is twice or more t seconds satisfying a condition A shown below; and a step C of drying the coating film after the step B at a rate at which the coating film shows a mass change of from 0.02 g/m²/s to 0.2 g/m2/s.

Condition A: In a case of measuring a dynamic surface tension of the coating liquid at a liquid temperature of 25° C. by a maximum bubble pressure method, γ2/γ1≤1.05 is satisfied, in which a dynamic surface tension at a bubble lifetime of 5 seconds is defined as γ1 and a dynamic surface tension at a bubble lifetime of t seconds which is shorter than 5 seconds is defined as γ2.

According to the production method of the present disclosure, it is possible to produce a film having excellent surface smoothness which is equal to or higher than that of a glass.

Furthermore, in the present disclosure, the surface smoothness of a film specifically represents the smoothness of a surface of a resin film formed on a support by performing the step A, the step B, and the step C.

Here, in the present disclosure, an expression, “surface smoothness which is equal to or higher than that of a glass”, means surface smoothness to such an extent that distortion is not visually recognized in a reflected image of a fluorescent lamp in a case where light from the fluorescent lamp is projected on the outermost surface on the viewing side of a film and the reflected image of the fluorescent lamp is visually observed.

Specifically, it can be confirmed by the following method whether a film having a support and a resin film (coating film) which is the outermost surface layer on the viewing side has the above-mentioned surface smoothness.

<Method for Confirming Surface Smoothness>

A film to be evaluated and an optical glass for a liquid crystal cell (manufactured by Corning, Inc., trade name: EAGLE XG, thickness: 400 μm) were bonded to each other using a pressure-sensitive adhesive sheet under a load of 2 kg applied thereto with a rubber roller such that the film surface layer (resin film)/the support/the pressure-sensitive adhesive layer of the pressure-sensitive adhesive sheet/the optical glass are laminated in this order. A surface of the optical glass, to which the film to be evaluated is not bonded, is bonded to a black PET film (trade name: KUKKIRI MIERU, manufactured by TOMOEGAWA Co., Ltd.) under a load of 2 kg applied thereto with a rubber roller, such that the optical glass and the pressure-sensitive adhesive became adjacent to each other. Light from a fluorescent lamp is projected onto the outermost surface on the viewing side of the film to be evaluated, the reflected image of the fluorescent lamp is observed, and the surface smoothness is confirmed from a presence or absence of distortion on the reflected image of the fluorescent lamp.

A reason why such an effect is exhibited by the production method of the present disclosure is not clear, but is presumed as follows by the present inventors. It should be noted that the following presumption is not a restrictive analysis on an effect of the production method of the present disclosure, but is described as an example.

That is, it is considered that the specific polymer contained in the coating liquid used in the production method of the present disclosure has a fluoroaliphatic group or a siloxane structure and exhibits a specific viscosity, whereby during a process where the coating film is dried, the specific polymer is unevenly distributed on a surface of the coating film, a variation in the film thickness of the coating film is suppressed, and thus high smoothness is expressed on the film surface. Furthermore, in order to exert the above-mentioned effect, it is necessary to secure a state where the specific polymer is sufficiently unevenly distributed on the surface of the coating film, and in this regard, in the production method of the present disclosure, the step B and the step C are performed as a step of drying the coating film, a state where the specific polymer is sufficiently unevenly distributed on the surface of the coating film is expressed by drying under the condition of a rate defined in the step B, and excellent surface smoothness is accomplished by performing drying under a condition of a rate defined in the step C.

Hereinafter, the step A, the step B, the step C, and the other optional steps in the production method of the present disclosure will be described.

The production method of the present disclosure may have other steps, in addition to the step A, the step B, and the step C.

(Step A)

The step A is a step of applying a coating liquid containing at least a film-forming compound, a specific polymer, and a solvent onto a support to form a coating film.

As the support, a resin base material can be used. Details of the resin base material which can be used as the support will be described later.

The coating liquid contains at least a film-forming compound, a specific polymer, and a solvent, and may also contain other components, as necessary.

The film-forming compound contained in the coating liquid is a compound capable of forming a matrix in a resin film and includes both of a polymerizable compound and a non-polymerizable resin, with the polymerizable compound being preferable. Further, the film-forming compound is a compound which is different from the specific polymer.

The specific polymer contained in the coating liquid is a polymer which has a fluoroaliphatic group or a siloxane structure, and is a compound capable of improving the surface smoothness of a film by controlling the fluidity of a surface of the coating film and effectively suppressing a variation in the film thickness at a time of performing the step B and the step C after the step A in a case where the specific polymer allows a solution having the polymer dissolved in methyl ethyl ketone at a solid content of 55% by mass to have a viscosity of 15 mPa·s or more at a liquid temperature of 60° C.

The viscosity of a solution having the specific polymer dissolved in methyl ethyl ketone at a solid content of 55% by mass is 15 mPa·s or more, preferably from 25 mPa·s to 50 mPa·s, and more preferably from 30 mPa·s to 40 mPa·s, at a liquid temperature of 60° C.

The present inventors have presumed that with the specific polymer exhibiting the above-mentioned viscosity, entanglement among the specific polymers occurs in the coating film, which may control the fluidity of a surface of the coating film, and may thus exert a certain action on suppression of a variation in the film thickness; however, the present disclosure is not limited to this presumption.

With regard to the viscosity, a solution having a specific polymer dissolved in methyl ethyl ketone at a solid content of 55% by mass is prepared, and the viscosity of the solution at a liquid temperature of 60° C. is measured using a viscometer.

The viscosity in the present disclosure is a measurement value as measured at a shear rate of 50 s⁻¹ using an electromagnetic spinning method. Specifically, an EMS viscometer “EMS-1000” manufactured by Kyoto Denshi Kogyo Co., Ltd. can be used as a measuring device.

Moreover, details of the respective components contained in the coating liquid will be described later.

The concentration of the solid contents of the coating liquid is preferably 60% by mass or more, more preferably from 65% by mass to 90% by mass, and still more preferably from 70% by mass to 80% by mass. In a case where the concentration of the solid contents of the coating liquid is 60% by mass or more, it is possible to produce a film having more excellent surface smoothness.

The coating amount of the coating liquid in the step A is preferably a coating amount such that the film thickness of the coating film is 25 μm or more, more preferably a coating amount such that the film thickness of the coating film is from 25 μm to 100 μm, and still more preferably a coating amount such that the film thickness of the coating film is from 30 μm to 50 μm.

Here, the film thickness of the coating film is a film thickness of the coating film before performing the step B, that is, before drying. The film thickness of the coating film can be measured on the coating film immediately after application, using a spectral interference method. Specifically, the film thickness of the coating film can be confirmed by “SI-T80” manufactured by Keyence Corporation.

The coating method of the coating liquid is not particularly limited and can be performed by applying a known application method. Examples of the application method include known methods such as a dip coating method, an air knife coating method, a curtain coating method, a roller coating method, a die coating method, a wire bar coating method, and a gravure coating method.

With regard to application of the coating liquid, an aspect in which a coating liquid having a concentration of a solid content of 60% by mass or more (more preferably the above-mentioned concentration of the solid content) is used and the coating liquid is applied at a coating amount such that the film thickness of the coating film is 25 μm or more (more preferably the above-mentioned coating amount) is particularly preferable. In the step A, a coating liquid having a concentration of the solid contents of 60% by mass or more is used, the coating liquid is applied at a coating amount such that the film thickness of the coating film is 25 μm or more, and therefore, in the step B which will be described later, uneven distribution of the specific polymer on a surface of the coating film is more effectively expressed, and thus, a film having more excellent surface smoothness is obtained.

With regard to the coating liquid used in the step A, a value obtained by subtracting a surface tension shown in a case of adjusting a concentration of the solid contents of the coating liquid to 60% by mass from a surface tension shown in a case of adjusting the concentration of the solid contents of the coating liquid to 90% by mass is preferably 1 mN/m or less.

The above-described expression, “the value obtained by subtracting a surface tension shown in a case of adjusting a concentration of the solid contents of the coating liquid to 60% by mass from a surface tension shown in a case of adjusting the concentration of the solid contents of the coating liquid to 90% by mass”, is a value calculated from the surface tensions measured for two coating liquids having the same solid composition and the same solvent and having concentrations of the solid content of 90% by mass and 60% by mass, respectively.

The surface tension of the coating liquid is a value measured at 25° C. using a surface tensiometer. As the surface tensiometer, a FACE automatic surface tensiometer CBVP-Z Type (manufactured by Kyowa Interface Science Co., Ltd.) can be used.

The viscosity of the coating liquid at a liquid temperature of 25° C. is preferably 5 mPa·s to 50 mPa·s, more preferably 10 mPa·s to 40 mPa·s, and still more preferably 15 mPa·s to 30 mPa·s.

A method for measuring the viscosity is as described above.

The application of the coating liquid in the step A may be performed on a sheet-like support or on a continuous support. In a case where the continuous support is used, a film can be produced by a so-called roll-to-roll process.

(Step B)

The step B is a step of drying the coating film formed in the step A at a rate at which the coating film shows a mass change of from 0.02 g/m²/s to 0.1 g/m²/s for a time which is twice or more t seconds satisfying a condition A shown below. The drying in the step B is drying that is positioned as primary drying.

Condition A

In a case of measuring a dynamic surface tension shown by a coating liquid at a liquid temperature of 25° C. by a maximum bubble pressure method, γ2/γ1≤1.05 is satisfied, in which a dynamic surface tension at a bubble lifetime of 5 seconds is defined as γ1 and a dynamic surface tension at a bubble lifetime of t seconds which is shorter than 5 seconds is defined as γ2.

In the above-mentioned condition A, the dynamic surface tension γ1 at a bubble lifetime of 5 seconds is an index of a dynamic surface tension shown by the coating liquid presumed to be in the state where drying in the step B proceeds and the specific polymer contained in the coating liquid is sufficiently unevenly distributed on a surface of the coating film. In addition, the dynamic surface tension γ2 at a bubble lifetime of t seconds which is shorter than 5 seconds corresponds to a dynamic surface tension shown by the coating liquid in the state where it does not reach the dynamic surface tension γ1 in the drying process in the step B.

Furthermore, the step B in the present disclosure is a step of performing drying at a rate at which the coating film shows a mass change of from 0.02 g/m²/s to 0.1 g/m²/s for a time which is twice or more t seconds satisfying a relationship (γ2/γ1≤1.05), the relationship being noted between the dynamic surface tensions γ1 and γ2 at a time of controlling a drying condition which makes it possible to accomplish a state where the specific polymer contained in the coating liquid is unevenly distributed on a surface of the coating film.

That is, performing drying at a specific rate in the step B, drying at a specific speed for a time in seconds which is twice or more t seconds satisfying the above-mentioned relationship in the step B means that drying is performed to secure a time until a step where the specific polymer is approximately unevenly distributed on a surface of the coating film.

The dynamic surface tension according to a maximum bubble pressure method can be measured using a surface tensiometer corresponding to the maximum bubble pressure method. As the surface tensiometer, specifically, SITA Pro line t15 (manufactured by SITA Lab Solutions), or the like can be used.

Moreover, “t seconds” only need to be determined by calculating the number of seconds satisfying γ2/γ1<<1.05 from a power approximation curve of the plots obtained by changing the bubble lifetime from 15 milliseconds up to 10 seconds. For example, the “t seconds” can be determined by calculating the number of seconds satisfying γ2/γ1=1.05.

The drying time in the step B is a time which is twice or more t seconds satisfying the condition A, and the drying time is preferably from two-fold to 20-fold t seconds, and more preferably from 2-fold to 10-fold t seconds.

The drying rate in the step B is a rate at which the coating film shows a mass change of from 0.02 g/m²/s to 0.1 g/m²/s.

The drying temperature in the step B is not particularly limited and can be appropriately set according to the composition of the coating liquid, and the drying temperature is preferably 25° C. to 60° C., more preferably 25° C. to 50° C., and still more preferably 25° C. to 40° C.

As the drying means, a known drying means can be used, and examples thereof include known drying means such as heat drying, hot air drying, and condensation drying.

(Step C)

The step C is a step of drying the coating film after the step B at a rate at which the coating film shows a mass change of from 0.02 g/m²/s to 0.2 g/m²/s. The step C is secondary drying which is performed after the step B. In the step C, the coating film in the state where the specific polymer is unevenly distributed on a surface of the coating film by the step B is further dried.

The drying rate in the step C is a rate at which the coating film shows a mass change of from 0.02 g/m²/s to 0.2 g/m2/s.

The drying rate in the step C may be any of a higher rate and a lower rate than the drying rate in the step B as long as it is within a range of rates at which the coating film shows a mass change of from 0.02 g/m²/s to 0.2 g/m²/s.

A transition from the step B to the step C can be determined from a change from a drying rate set to be within a range of the mass change of from 0.02 g/m²/s to 0.1 g/m²/s to another drying rate at which the coating film shows a mass change of 0.02 g/m²/s to 0.2 g/m²/s.

For example, in a case where the drying in the step B and the step C is performed using a device in which drying is carried out in the respective separate drying zones, a transition from the step B to the step C can be determined by setting the drying conditions of the respective drying zones to the conditions within the ranges of each of the step B and the step C, respectively.

Furthermore, in a case where the drying in the step B and the step C is performed using a device in which drying is carried out in a single drying zone, a transition from the step B to the step C can be determined by modification of the drying condition of the drying zone from the condition within the range of the step B to the condition within the range of the step C.

In addition, the step B and the step C may be carried out at the same drying rate, or the step B and the step C may be carried out in series as the same step. In this case, the step B also serves as the step C.

Moreover, in the production method of the present disclosure, the drying at a rate of less than 0.02 g/m²/s may be subsequently performed in the step C.

The drying time in the step C is not particularly limited, and can be defined as a time taken until the drying rate of the coating film shows a mass change of less than 0.02 g/m²/s.

The drying temperature in the step C may be the same as the temperature in the step B or may be different from the temperature in the step B. The drying temperature in the step C is preferably 25° C. to 80° C., more preferably 25° C. to 70° C., and still more preferably 25° C. to 60° C.

Examples of the drying means in the step C include the same drying means as that in the step B.

(Other Steps)

The production method of the present disclosure may have other steps, in addition to the above-mentioned step A, step B, and step C. Examples of such other steps include a step of irradiating the coating film with actinic energy rays (step D).

<Step D>

In a case where the coating liquid in the present disclosure is a coating liquid including a polymerizable compound as the film-forming compound, the production method of the present disclosure preferably has a step of irradiating the coating film with actinic energy rays (step D). Irradiation with actinic energy rays in the step D is carried out after the step C (secondary drying).

Examples of the actinic energy rays include actinic energy rays such as X-rays, electron beams, ultraviolet rays, visible light, and infrared rays, and the ultraviolet rays are preferable.

For example, it is preferable that the coating film is cured by irradiating the coating film with ultraviolet rays at an irradiation dose of 10 mJ/cm² to 1,000 mJ/cm² with an ultraviolet lamp. Upon irradiation, the energy may be irradiated at once or separately. In particular, from the viewpoints of alleviating a performance variation in the plane of the coating film and improving the curling, it is preferable to irradiate the coating film two or more separate times, and it is also preferable to irradiate the coating film with ultraviolet rays at a low irradiation dose of 150 mJ/cm² or less in the initial stage, and then with ultraviolet rays at a high irradiation dose of 50 mJ/cm² or more, and furthermore, irradiate the coating film at a higher irradiation dose in the latter stage than in the initial stage.

The surface smoothness of a film obtained by the production method of the present disclosure can be evaluated as reference to a ratio of the maximum height roughness Rz of the surface of the coating layer formed on the support to the film thickness has an index. The specific evaluation method and evaluation means will be described in Examples which will be described later.

The hardness of a film obtained by the production method of the present disclosure (that is, the hardness of a surface of the resin film formed) is preferably 2H or more, more preferably 3H to 9H, and still more preferably 4H to 8H. The hardness of the film can be measured by a pencil hardness test in accordance with JIS K5600-5-4 (1999).

The production method of the present disclosure can be carried out with a production device having at least a coating means and a drying means. Examples of the production device which can carry out the production method of the present disclosure include a device comprising a dryer using hot air, a heater, or a condensing plate, and a drying device using hot air. In addition, the device described in JP4951301B can be suitably applied.

Examples of applications of a film produced by the production method of the present disclosure include a surface protection film comprised in a touch panel, an image display device, or the like, and a protective film for window glasses of automobiles.

Hereinafter, the support used for the production method of the present disclosure and the respective components which can be contained in the coating liquid will be described in detail.

<Support>

As the support, a resin base material can be used.

As a plastic base material, a film-shaped resin base material (hereinafter also referred to as a resin film) can be used. The resin film may be a single-layer resin film or may be a laminated film in which two or more resin films are laminated.

The resin film may be obtained as a commercially available product or may be a resin film produced by a known film forming method.

Examples of the resin film include an acrylic resin film, a polycarbonate resin film, a polyolefin resin film, a polyester resin film, an acrylonitrile butadiene styrene copolymer (ABS) film, and a triacetyl cellulose (TAC) film.

In a preferred aspect, the resin film includes at least one film selected from the group consisting of a triacetyl cellulose film, an acrylic resin film, and a polycarbonate resin film, and the triacetyl cellulose film is more preferable. Further, in another preferred aspect, the resin film is a laminated film having two or more resin films. Here, the number of layers is, for example, 2 or 3, but is not particularly limited thereto.

In addition, the acrylic resin film is a resin film including a polymer or copolymer including one or more monomer units selected from the group consisting of an acrylic acid ester and a methacrylic acid ester, and examples thereof include a polymethyl methacrylate resin (PMMA) film.

The thickness of the resin film is preferably in the range of 15 μm to 800 μm, more preferably in the range of 20 μm to 500 μm, and still more preferably in the range of 200 μm to 500 μm. Further, a case where the resin film is a laminated film, the thickness of the resin film refers to a total thickness of the laminated film.

The surface of the resin film may be optionally subjected to an adhesion promoting treatment such as a corona discharge treatment by a known method.

<Film-Forming Compound>

The coating liquid contains a film-forming compound.

The film-forming compound is a compound capable of forming a resin film, and includes both of a polymerizable compound and a non-polymerizable resin. It is preferable that the film-forming compound is a polymerizable compound from the viewpoint of producing a film having high hardness and surface smoothness.

Polymerizable Compound

The polymerizable compound in the present disclosure is a compound having a polymerizable group, which causes a polymerization reaction by itself upon application of actinic energy rays or causes a polymerization reaction by the action of components such as a polymerization initiator activated by receiving actinic energy rays.

The polymerizable compound may be either a radically polymerizable compound or a cationically polymerizable compound. Both of the radically polymerizable compound and the cationically polymerizable compound may be used in combination.

The polymerizable compound may be any of compounds having one or more polymerizable groups in the molecule, and preferably has two or more polymerizable groups in the molecule. By using a polymerizable compound having three or more polymerizable groups in the molecule, it is possible to produce a film having higher hardness.

Examples of the polymerizable group include a radically polymerizable group such as a (meth)acryloyl group, a vinyl group, a styryl group, and an allyl group, and a functional group such as an epoxy group, and among these, the (meth)acryloyl group, —C(O)OCH═C, or the epoxy group is preferable, and the (meth)acryloyl group or the epoxy group is more preferable.

From the viewpoint of curing properties, one suitable aspect of the polymerizable compound is a compound having one or more (meth)acryloyl groups in the molecule, and a compound having three or more (meth)acryloyl groups in the molecule is more preferable.

In addition, from the viewpoints of curing properties and suppression of moisture permeation, another suitable aspect of the polymerizable compound is a compound having one or more epoxy groups in the molecule.

Examples of the polymerizable compound include an ester of a polyhydric alcohol and a (meth)acrylic acid, vinyl benzene and a derivative thereof, vinyl sulfone, and (meth)acrylamide.

Among those, the ester of a polyhydric alcohol and a (meth)acrylic acid is preferable, and examples of the ester include diethylene glycol dimethacrylate, pentaerythritol tetra(meth)acrylate, pentaerythritol tri(meth)acrylate, trimethylolpropane tri(meth)acrylate, ethylene oxide (EO)-modified trimethylolpropane tri(meth)acrylate, propylene oxide (PO)-modified trimethylolpropane tri(meth)acrylate, EO-modified phosphate tri(meth)acrylate, trimethylolethane tri(meth)acrylate, ditrimethylol Propane tetra(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, poly ester polyacrylate, and caprolactone-modified tris(acryloyloxyethyl) isocyanurate.

As the polymerizable compound, it is also preferable to use a compound having one or more epoxy groups in the molecule, in addition to the compound having a (meth)acryloyl group. As the compound having one or more epoxy groups in the molecule, a compound represented by General formula (1) is preferable.

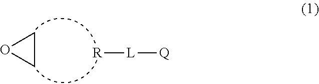

In General Formula (1), R represents a monocyclic hydrocarbon or a crosslinked hydrocarbon, L represents a single bond or a divalent linking group, and Q represents an ethylenically unsaturated double-bonding group, or a ring-opening polymerizable group. Incidentally, L may not be present, and R and Q may be directly bonded to each other.

As the compound represented by General Formula (1), a compound represented by General Formula (1A) or (1B) is more preferable, and the compound represented by General Formula (1A), having a low molecular weight is still more preferable. Further, an isomer of the compound represented by General Formula (1A) is also preferable.

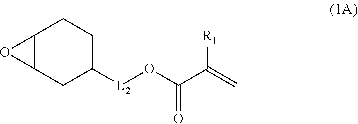

In General Formula (1A), R₁ represents a hydrogen atom or a methyl group, and L₂ represents a divalent aliphatic hydrocarbon group having 1 to 6 carbon atoms.

In General Formula (1A), L₂ preferably has 1 to 3 carbon atoms, and still more preferably has one carbon atom (epoxycyclohexylmethyl (meth)acrylate).

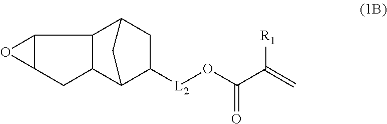

In General Formula (1B), R₁ represents a hydrogen atom or a methyl group, and L₂ represents a divalent aliphatic hydrocarbon group having 1 to 3 carbon atoms.

L₂ in General Formula (1B) still preferably has one carbon atom. As the divalent aliphatic hydrocarbon group, a linear, branched, or cyclic alkylene group is preferable, the linear or branched alkylene group is more preferable, and the linear alkylene group is still more preferable.

In addition to the above-mentioned compounds, the polymerizable compounds described in paragraph Nos. [0039] to [0083] of JP2017-095711A can be preferably applied as the polymerizable compound in the present disclosure.

As the polymerizable compound, a commercially available product can be used. Examples of the commercially available product include KAYARD DPHA and PET-30 (both manufactured by Nippon Kayaku Co., Ltd.), NK Ester A-TMMT and NK Ester A-TMPT (both manufactured by Shin-Nakamura Chemical Co., Ltd.), and Light Ester 2EG (manufactured by Kyoeisha Chemical Co., Ltd.), and Cyclomer M100 (manufactured by Daicel Corporation).

From the viewpoint of the hardness of the film, molecular weight of the polymerizable compound is not particularly limited, but is preferably 600 or less, and more preferably 360 or less. In addition, from the viewpoint of suppressing volatilization at the time of film formation, the molecular weight of the polymerizable compound is preferably 80 or more, and more preferably 120 or more.

In a case where a polymerizable compound is used as the film-forming compound, the content of the polymerizable compound is preferably 80% by mass to 99% by mass, and more preferably 90% by mass to 98% by mass, with respect to the total solid content of the coating liquid.

The coating liquid may contain a non-polymerizable resin as the film-forming compound, and examples of the non-polymerizable resin which may be contained in the coating liquid of the present disclosure include cellulose acetate propionate and cellulose acetate butyrate.

In a case where a non-polymerizable resin is used as the film-forming compound, the content of the non-polymerizable resin may be set appropriately within a range not impairing the effect of improving the surface smoothness in the present disclosure. For example, the content is preferably 0.5% by mass to 5% by mass, and more preferably 1% by mass to 3% by mass, with respect to the total solid content of the coating liquid.

<Specific Polymer>

The coating liquid contains a polymer (specific polymer) which is at least one selected from a polymer having a fluoroaliphatic group or a polymer having a siloxane structure, and allows a solution having the polymer dissolved in methyl ethyl ketone at a solid content of 55% by mass to have a viscosity of 15 mPa·s or more at a liquid temperature of 60° C.

Details of the above-mentioned viscosity shown by the solution of the specific polymer are described as above.

Polymer Having Fluoroaliphatic Group

The polymer having a fluoroaliphatic group refers to a polymer having at least one fluoroaliphatic group in the molecule.

Here, the fluoroaliphatic group means a group in which at least one of the hydrogen atoms of the aliphatic group is substituted with a fluorine atom. As the fluoroaliphatic group, a fluoroalkyl group is preferable, and a fluoroalkyl group having one or more carbon atoms is more preferable. The fluoroalkyl group may be a perfluoroalkyl group. The fluoroalkyl group may have a substituent other than the fluorine atom.

As the polymer having a fluoroaliphatic group, a polymer containing a repeating unit corresponding to a monomer represented by General Formula 1 is preferable.

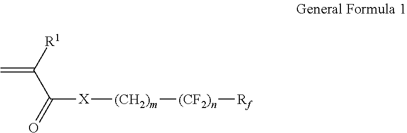

In General Formula 1, R¹ represents a hydrogen atom, a halogen atom, or a methyl group. X represents an oxygen atom, a sulfur atom, or —N(R¹²)—. R¹² represents a hydrogen atom or an alkyl group having 1 to 8 carbon atoms. R_{f} represents —CF₃ or CF₂H. m represents an integer of 1 to 6. n represents an integer of 1 to 11.

Examples of the polymer containing a repeating unit corresponding to a monomer represented by General Formula 1 (hereinafter also referred to as a monomer (i)) include a homopolymer having a constitutional unit corresponding to the monomer (i), a copolymer including a constitutional unit corresponding to a monomer represented by General Formula 2 (hereinafter also referred to as a monomer (ii)) copolymerizable with the monomer (i), and a copolymer of the monomer (i) or a vinyl-based monomer copolymerizable with the monomers (i) and (ii). As such the vinyl-based monomer, ones described in Polymer Handbook 2^{nd} ed., J. Brandrup, Wiley Interscience (1975) Chapter 2, Pages 1-483 can be used, and examples of the vinyl-based monomer include a compound having one addition polymerizable unsaturated bond selected from acrylic acid, methacrylic acid, acrylic acid esters, methacrylic acid esters, acrylamides, methacrylamides, allyl compounds, vinyl ethers, vinyl esters, and the like.

The monomer represented by General Formula 1 [monomer (i)] will be described.

In General Formula 1, R¹ represents a hydrogen atom, a halogen atom, or a methyl group, and is preferably the hydrogen atom or the methyl group. X represents an oxygen atom, a sulfur atom, or —N(R¹²)—, and is preferably the oxygen atom or —N(R¹²)—, and still more preferably the oxygen atom. R¹² represents a hydrogen atom or an alkyl group having 1 to 8 carbon atoms, and is preferably a hydrogen atom or an alkyl group having 1 to 4 carbon atoms, and more preferably the hydrogen atom or a methyl group. Rf represents —CF₃ or —CF₂H.

In General Formula 1, m represents an integer of 1 to 6, is more preferably 1 to 3, and still more preferably 1.

In General Formula 1, n represents an integer of 1 to 11, is more preferably 1 to 9, and still more preferably 1 to 6. Rf is preferably —CF₂H.

Two or more kinds of constitutional units corresponding to a monomer containing a fluoroaliphatic group, represented by General Formula 1, may be included in the polymer having a fluoroaliphatic group.

The monomer represented by General Formula 2 [monomer (ii)] copolymerizable with the monomer (i) will be described.

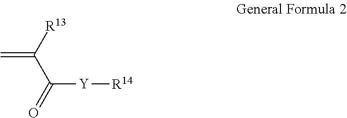

In General Formula 2, R¹³ represents a hydrogen atom, a halogen atom, or a methyl group, and is more preferably the hydrogen atom or the methyl group. Y represents an oxygen atom, a sulfur atom, or —N(R¹⁵)—, and is more preferably the oxygen atom or —N(R¹⁵)—, and still more preferably the oxygen atom. R¹⁵ represents a hydrogen atom or an alkyl group having 1 to 8 carbon atoms, and is more preferably the hydrogen atom or the alkyl group having 1 to 4 carbon atoms, and still more preferably the hydrogen atom or the methyl group.

R¹⁴ represents a linear, branched, or cyclic alkyl group having 1 to 60 carbon atoms, or an aromatic group (for example, a phenyl group or a naphthyl group). The alkyl group represented by R¹⁴ may contain a poly(alkyleneoxy) group. As the alkyl group represented by R¹⁴, a linear, branched, or cyclic alkyl group having 1 to 20 carbon atoms is more preferable, and a linear or branched alkyl group having 1 to 10 carbon atoms is still more preferable.

The amount of the monomer (i) to be used for production of the polymer having a fluoroaliphatic group is preferably 10% by mass or more, more preferably 25% by mass or more, and still more preferably in the range of 40% by mass to 90% by mass, with respect to the total amount of the monomers of the polymer having a fluoroaliphatic group.

Specific examples of the polymer having a fluoroaliphatic group include the polymers exemplified in paragraph Nos. [0041] to [0046] of JP5933353B, but the polymer having a fluoroaliphatic group in the present disclosure is not particularly limited thereto.

The weight-average molecular weight of the polymer having a fluoroaliphatic group is preferably 3,000 to 100,000, and more preferably 5,000 to 80,000.

In the present disclosure, the weight-average molecular weight (Mw) means a value as measured by gel permeation chromatography (GPC).

In the present disclosure, measurement by gel permeation chromatography (GPC) can be performed using a measuring device of an HLC (registered trademark)-8020GPC (Tosoh Corporation), three columns of TSKgel (registered trademark) Super Multipore HZ-H (4.6 mm IDx15 cm, Tosoh Corporation), and tetrahydrofuran (THF) as an eluent. In addition, the measurement is performed using a differential refractive index (RI) detector under measurement conditions of a sample concentration of 0.45% by mass, a flow rate of 0.35 ml/min, a sample injection amount of 10 μl, a measurement temperature of 40° C.

The calibration curve is created with “Standard samples TSK standard, polystyrene” from Tosoh Corporation: 8 samples of “F-40”, “F-20”, “F-4”, “F-1”, “A-5000”, “A-2500”, “A-1000”, and “n-propylbenzene”.

Polymer Having Siloxane Structure

The polymer having a siloxane structure refers to a polymer having a siloxane bond (Si—O—Si bond) as a partial structure in the molecule.

In a case where a polymer having a siloxane structure is used as the specific polymer, a polymer allowing a solution having the polymer dissolved in methyl ethyl ketone at a solid content of 55% by mass to have a viscosity of 15 mPa·s or more at a liquid temperature of 60° C. is selected from the polymers having a siloxane structure.

As the polymer having a siloxane structure, a commercially available product may be used. Examples of the commercially available product include, but are not limited to, X-22-174DX, X-22-2426, X22-164C, and X-22-176D (all trade names) manufactured by Shin-Etsu Chemical Co., Ltd., and SH200, L7604, FZ-2105, L-7604, Y-7006, and SS-2801 (all trade names) manufactured by Dow Corning Toray Co., Ltd.

The content of the specific polymer in the coating liquid is preferably 0.01% by mass to 3% by mass, more preferably 0.03% by mass to 2% by mass, and still more preferably 0.05% by mass to 1% by mass, with respect to the total amount of the coating liquid, from the viewpoint of the surface smoothness of a film.

<Solvent>

The solvent is preferably selected from organic solvents in which the respective components contained in the coating liquid can be dissolved or dispersed.

Specific examples of the solvent include alcohols such as methanol, ethanol, propanol, n-butanol, and i-butanol; ketones such as acetone, methyl isobutyl ketone, methyl ethyl ketone, and cyclohexanone; cellosolves such as ethyl cellosolve; aromatic solvents such as toluene and xylene; glycol ethers such as propylene glycol monomethyl ether; acetic acid esters such as methyl acetate, ethyl acetate, and butyl acetate; and diacetone alcohol.

The solvents may be used singly or in combination of two or more kinds thereof.

In a case where two or more kinds of the solvents are used, it is preferable to combine the solvents from the viewpoints of the drying rate and the solubility of components contained in the coating liquid.

Preferred examples of the combination of the solvents include a combination of cyclohexanone and methyl ethyl ketone, and a combination of methyl ethyl ketone and methyl acetate, and from the viewpoint of the drying rate (slow drying), the combination of cyclohexanone and methyl ethyl ketone is more preferable.

The content of the solvent in the coating liquid can be appropriately adjusted within a predetermined range in which coating suitability can be secured. As described above, the concentration of the solid contents in the coating liquid of the present disclosure is preferably 60% by mass or more, and the content of the solvent in the coating liquid is preferably contained in an amount such that the concentration of the solid contents is 60% by mass or more.

<Polymerization Initiator>

In a case where the coating liquid contains a polymerizable compound as the film-forming compound, it is preferable that the coating liquid further contains a polymerization initiator.

The polymerization initiators may be used singly or in combination of two or more kinds thereof.

As the polymerization initiator, a commercially available compound can be used, and for example, the compound described in “Advanced UV Curing Technologies” (p. 159, publisher; Kazuhiro Takausu, Publishing company; Technical Information Institute Co., Ltd., published in 1991) or catalogues of BASF can be used.

As the polymerization initiator, any polymerization initiator of a radical polymerization initiator and a cationic polymerization initiator may be used.

As the radical polymerization initiator, an alkylphenone-based photopolymerization initiator (for example, Irgacure 651, Irgacure 184, DAROCURE 1173, Irgacure 2959, Irgacure 127, DAROCURE MBF, Irgacure 907, Irgacure 369, and Irgacure 379EG), an acylphosphine oxide-based photopolymerization initiator (for example, Irgacure 819 and LUCIRIN TPO), others (for example, Irgacure 784, Irgacure OXE01, Irgacure OXE02, and Irgacure 754), or the like can be used (all of the exemplified compounds in parentheses are radical polymerization initiators manufactured by BASF.).

The content of the radical polymerization initiator is preferably in the range of 0.1% by mass to 10% by mass, more preferably 1% by mass to 5% by mass, and still more preferably 2% by mass to 4% by mass, with respect to 100% by mass of the total solid content of the coating liquid.

Examples of the cationic polymerization initiator include well-known compounds such as well-known acid generators which are used in light initiators for light cationic polymerization, light color extinction agents and light discoloring agents for coloring agents, micro-resists, and the like, and mixtures thereof.

Examples of the cationic polymerization initiator include an onium compound, an organic halogen compound, and a disulfone compound. Specific examples of the organic halogen compound and the disulfone compound include the same compounds as described in the section of the above-described radical-generating compounds.

Examples of the onium compounds include a diazonium salt, an ammonium salt, an iminium salt, a phosphonium salt, an iodonium salt, a sulfonium salt, an arsonium salt, and a selenonium salt, and for example, the compounds described in paragraph Nos. [0058] to [0059] of JP2002-029162A.

Examples of the cationic polymerization initiator which is suitably used include an onium salt, and from the viewpoint of the light sensitivity in photopolymerization initiation, the material stability of a compound, and the like, a diazonium salt, an iodonium salt, a sulfonium salt, or an iminium salt is preferable, and among these, the iodonium salt is the most preferable from the viewpoint of light resistance.

Specific examples of the onium salt which can be suitably used include the acylated sulfonium salts described in paragraph No. [0035] of JP1997-268205A (for example, JP-H09-268205A), the diaryliodonium salts or the triarylsulfonium salts described in paragraph Nos. [0010] and [0011] of JP2000-071366A, the sulfonium salts of thiobenzoate S-phenyl esters described in paragraph No. [0017] of JP2001-288205A, and the onium salts described in paragraph Nos. [0030] to [0033] of JP2001-133696A.

Other examples thereof include the organic metals/organic halides described in paragraph Nos. [0059] to [0062] of JP2002-029162A, photoacid generators having an o-nitrobenzyl-type protective group, and compounds such as a compound which is decomposed by light to generate sulfonic acid (for example, iminosulfonate).

As specific compounds of the iodonium salt-based cationic polymerization initiator, B2380 (manufactured by Tokyo Chemical Industry Co., Ltd.), BBI-102 (manufactured by Midori Kagaku Co., Ltd.), WPI-113 (manufactured by Wako Pure Chemical Industries, Ltd.), WPI-124 (manufactured by Wako Pure Chemical Industries, Ltd.), WPI-169 (manufactured by Wako Pure Chemical Industries, Ltd.), WPI-170 (manufactured by Wako Pure Chemical Industries, Ltd.), DTBPI-PFBS (manufactured by Toyo Gosei Co., Ltd.), DTBPI-CS (manufactured by Toyo Gosei Co., Ltd.), PI-2074 (manufactured by Rhodia Japan Co., Ltd.), or the like can be used.

The cationic polymerization initiators may be used singly or in combination of two or more kinds thereof.

The content of the cationic polymerization initiator is preferably in the range of 0.1% by mass to 10% by mass, and more preferably in the range of 0.3% by mass to 3.0% by mass, with respect to 100% by mass of the total solid content of the coating liquid.

<Other Components>

The coating liquid may contain other components, as necessary, in addition to the above-described components.

Examples of such other components include a polymerization inhibitor and an ultraviolet absorber.

### EXAMPLES

Hereinbelow, the present invention will be described in more detail with reference to Examples, but should not be construed as being limited to Examples shown below as long as Examples do not deviate from the subject matter of the present invention.

### Examples 1 to 12 and Comparative Examples 1 to 6

<Step A>

1. Preparation of Coating Liquids A-1 to A-9

The compositions shown in Table 1 or 2 below were mixed and the obtained mixed liquid was filtered through a polypropylene-made filter having a pore diameter of 10 μm, thereby preparing coating liquids A-1 to A-9.

TABLE 1

| | A-1 | A-2 | A-3 | A-4 |
|---|---|---|---|---|
| Film-forming | KAYARD | KAYARD | KAYARD | KAYARD |
| compound | DPHA | DPHA | DPHA | DPHA |
| (polymerizable | 100 parts by mass | 100 parts by mass | 100 parts by mass | 100 parts by mass |
| compound) | Light Ester 2EG | Light Ester 2EG | Light Ester 2EG | Light Ester 2EG |
| | 100 parts by mass | 100 parts by mass | 100 parts by mass | 100 parts by mass |
| Polymerization | Irg184 | Irg184 | Irg184 | Irg184 |
| initiator | 7.7 parts by mass | 7.7 parts by mass | 7.7 parts by mass | 7.7 parts by mass |
| | None | None | None | None |
| | — | — | — | — |
| Specific | Polymer B3 | Polymer B1 | Polymer B2 | Polymer B4 |
| polymer | 0.26 parts by mass | 0.26 parts by mass | 0.26 parts by mass | 0.26 parts by mass |
| Solvent | Cyclohexanone | Cyclohexanone | Cyclohexanone | Cyclohexanone |
| | 51 parts by mass | 51 parts by mass | 51 parts by mass | 51 parts by mass |
| | MEK | MEK | MEK | MEK |
| | 1 part by mass | 1 part by mass | 1 part by mass | 1 part by mass |
| | None | None | None | None |
| | — | — | — | — |

TABLE 2

| | A-5 | A-6 | A-7 | A-8 | A-9 |
|---|---|---|---|---|---|
| Film-forming | KAYARD | KAYARD | KAYARD | KAYARD | PET-30 |
| compound | DPHA | DPHA | DPHA | DPHA | |
| (polymerizable | 100 parts by mass | 100 parts by mass | 100 parts by mass | 100 parts by mass | 100 parts by mass |
| compound) | Cyclomer M100 | Cyclomer M100 | Light Ester 2EG | Light Ester 2EG | Light Ester 2EG |
| | 43 parts by mass | 150 parts by mass | 100 parts by mass | 100 parts by mass | 100 parts by mass |
| Polymerization | Irg184 | Irg184 | Irg184 | Irg184 | Irg184 |
| initiator | 5.6 parts by mass | 9.6 parts by mass | 7.7 parts by mass | 7.7 parts by mass | 7.7 parts by mass |
| | CPI-100P | CPI-100P | None | None | None |
| | 2.8 parts by mass | 4.9 parts by mass | — | — | — |
| Specific polymer | Polymer B1 | Polymer B1 | None | Polymer B3 | Polymer B3 |
| | 0.25 parts by mass | 0.38 parts by mass | — | 0.26 parts by mass | 0.26 parts by mass |
| Solvent | Cyclohexanone | None | Cyclohexanone | None | Cyclohexanone |
| | 99.5 parts by mass | — | 51 parts by mass | — | 51 parts by mass |
| | MEK | MEK | MEK | MEK | MEK |
| | 1.5 parts by mass | 36.4 parts by mass | 1 part by mass | 28.6 parts by mass | 1 part by mass |
| | None | Methyl acetate | None | Methyl acetate | None |
| | — | 29.8 parts by mass | — | 23.4 parts by mass | — |

Details of the respective components described in Table 1 or 2 are as follows.
KAYARD DPHA (manufactured by Nippon Kayaku Co., Ltd., polymerizable compound)
PET-30 (manufactured by Nippon Kayaku Co., Ltd., polymerizable compound)
Light Ester 2EG (manufactured by Kyoeisha Chemical Co., Ltd., polymerizable compound)
Cyclomer M100 (manufactured by Daicel Corporation, polymerizable compound).
Irg184: Alkylphenone-based photopolymerization initiator (manufactured by BASF)
CPI-100P: Photocationic polymerization initiator, triarylsulfonium salt (manufactured by San-Apro Ltd.)

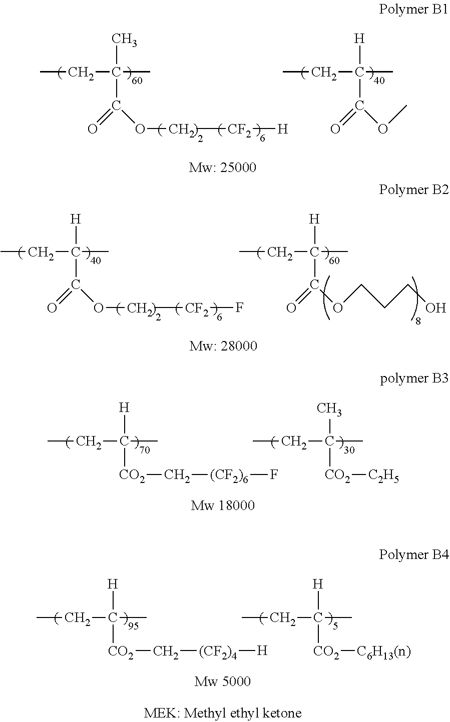

The concentration of the solid contents and the viscosity at a liquid temperature of 25° C. of the coating liquids A-1 to A-9 obtained above are shown in Table 3 or 4 below.

In addition, the viscosity at a liquid temperature of 25° C. of a solution (solid content of 55% by mass) in which the specific polymer used for each coating liquid was dissolved in MEK are shown in Table 3 or 4 below. Further, the viscosity of the solution was measured by the measurement method as described above.

Moreover, each of sample liquids having the same compositions of the solid contents as for the coating liquids A-1 to A-9 and having concentrations of the solid content adjusted to 90% by mass or 60% by mass by changing the amounts of the solvent was prepared and the surface tension of each of the sample liquids was measured by the method as described above. In addition, with regard to the coating liquids (having a concentration of the solid contents of 60% by mass) used in Examples 6 and 9, only a sample liquid having a concentration of the solid contents of 90% by mass was prepared.

With regard to the sample liquid corresponding to each of the coating liquids, a value obtained by subtracting a surface tension shown in a case of adjusting a concentration of the solid contents of the sample liquid to 60% by mass from a surface tension shown in a case of adjusting the concentration of the solid contents of the sample liquid to 90% by mass was calculated. The results are shown in Table 3 or 4.

2. Application of Coating Liquid

Each of the coating liquids obtained above was manually applied onto a support (triacetyl cellulose (TAC) film, thickness: 120 μm) in a coating amount such that the film thickness described in Table 3 or 4 was achieved, using a bar coater, thereby forming a coating film.

For the coating liquid having a concentration of the solid contents of 80% by mass, a bar coater with a count number of #20 was used; for the coating liquid having a concentration of the solid contents of 60% by mass, a bar coater with a count number of #26 was used; and for the coating liquid having a concentration of the solid contents of 50% by mass, a bar coater with a count number of #32 was used.

<Step B>

For the coating film formed on each support, the step B (primary drying) was performed under the drying condition (the drying rate and the drying time) shown in Table 3 or 4.

The drying time is a time which is twice or more as long as “t seconds” obtained as follows, and was set to the drying time shown in Table 3 or 4.

For each of the coating liquids, a dynamic surface tension γ1 was obtained using SITA Pro line t15 (manufactured by SITA Lab Solutions) at a liquid temperature of 25° C. with a bubble lifetime measured up to 5,000 ms. In addition, a bubble lifetime for a dynamic surface tension γ2 satisfying γ2/γ1=1.05 was defined as “t seconds”.

As a drying means, a hot air dryer (manufactured by Yamato Scientific Co., Ltd., Clean Oven DE42) was used.

<Step C>

The coating film after the step B (primary drying) was subsequently subjected to a step C (secondary drying) under the drying condition (drying rate and drying time) shown in Table 3 or 4. The drying means was the same as in the step B.

<Step D>

The coating film after the step C was irradiated with ultraviolet rays at an illuminance of 400 mW/cm² and an irradiation dose of 1,000 mJ/cm² under the condition of nitrogen at 0.1 ppm or less to cure the coating film.

Thus, the respective films of Examples 1 to 11 and Comparative Examples 1 to 6 were produced.

### Example 12

A coating liquid A-1 was applied onto a support drawn from a support roll (triacetyl cellulose (TAC) film roll, manufactured by Fujifilm Corporation, thickness: 120 μm) under the condition of a transport rate of 10 m/min, using the die coater described in Example 1 of JP2006-122889A, thereby forming a coating film (Step A), and the formed coating film was dried at the drying temperature and the drying time shown in Table 3 or 4 (Step B and Step C), and after drying, the coating film was further irradiated with ultraviolet rays at an illuminance of 400 mW/cm² and an irradiation dose of 1,000 mJ/cm² under the condition of an oxygen concentration of about 0.1 ppm or less under a nitrogen purge and cured (step D), and then the coating film was wound.

In this manner, a film of Example 12 was produced.

Furthermore, any of the hardness of a surface on the resin film side of each of the films obtained in Examples, as measured in accordance with the pencil hardness test as described above, was in the range of 4H to 8H.

[Evaluation of Surface Smoothness]

The surface condition of the obtained film was evaluated according to the following evaluation method and evaluation standard, and the evaluation of the surface condition was used as an index of the surface smoothness of a film. The results are shown in Table 3 or 4.

<Evaluation Method>

Each of the films obtained in Examples and Comparative Examples was cut into a size of 10 cm×3 cm.

The side on which the coating film (resin film) of each cut film was not formed was bonded onto an SiC wafer (product name: 4H-N, manufactured by MTK) with a pressure-sensitive adhesive sheet created below, thereby creating an evaluation sample.

With respect to the surface on the resin film side of each evaluation sample, a roughness curve was measured using a high-precision microfigure measuring instrument Surfcorder ET4000A (Kosaka Laboratory Ltd.), and a maximum height roughness Rz was calculated.

In addition, the film thickness h of the resin film of each evaluation sample was measured using a spectral reflection film thickness meter FE-3000 (Otsuka Electronics Co., Ltd.).

A ratio (Rz/h) of the obtained maximum height roughness Rz to the film thickness h was calculated, and the surface condition was evaluated according to the following evaluation standard. Evaluation ranks A and B are levels at which there is no problem in practical use, and the evaluation rank A indicates that the surface smoothness is more excellent.

<Evaluation Standard>

A: Rz/h is less than 0.04.

B: Rz/h is 0.04 or more and less than 0.08.

C: Rz/h is 0.08 or more and less than 0.12.

D: Rz/h is 0.12 or more.

Manufacture of Pressure-Sensitive Adhesive Sheet

(1) Preparation of Pressure-Sensitive Adhesive Composition

To a reaction vessel comprising a cooling pipe, a nitrogen introduction pipe, a thermometer, and a stirrer was added an emulsion of raw materials of monomers, in which 96 parts by mass of butyl acrylate (BA), 4 parts by mass of acrylic acid (AA), 0.08 part by mass of t-dodecanethiol (chain transfer agent), 2 parts by mass of sodium polyoxyethylene lauryl sulfate (emulsifier), and 153 parts by mass of ion exchange water were emulsified, and the mixture was stirred at room temperature (25° C.) for one hour while introducing a nitrogen gas into the reaction vessel.

Thereafter, the mixture was heated to a liquid temperature of 60° C., 0.1 parts by mass, in terms of a solid content, of 2,2′-azobis [N-(2-carboxy ethyl)-2-methylpropionamidine]hydrate (polymerization initiator) (trade name: VA-057, manufactured by Wako Pure Chemical Industries, Ltd.) prepared in the form of a 10%-by-mass aqueous solution was added thereto, and the mixture was polymerized under stirring at 60° C. for 3 hours. A 10%-by-mass aqueous ammonia was added to the reaction solution so as to adjust the pH of the solution to 7.5, thereby obtaining an aqueous dispersion-type (meth)acrylic polymer (A).

70 parts by mass, in terms of a solid content, of the aqueous dispersion-type (meth)acrylic polymer (A) obtained as above and 30 parts by mass, in terms of a solid content, of a synthetic polyisoprene latex (trade name: CEPOREX IR-100K, manufactured by Sumitomo Seika Chemicals Company, Ltd.) were formulated together. Then, 25 parts by mass, in terms of a solid content, of an aromatic modified terpene resin emulsion (trade name: NANOLET R-1050, manufactured by YASUHARA Chemical Co., Ltd., softening point: 100° C.) as a viscosity imparting agent was mixed therewith and the mixture was further mixed with 0.07 parts by mass of an epoxy-based crosslinking agent (trade name: TETRAD-C, manufactured by Mitsubishi Gas Chemical Co., Inc.), thereby preparing an aqueous dispersion-type pressure-sensitive adhesive composition.

(2) Manufacture of Pressure-Sensitive Adhesive Sheet

The pressure-sensitive adhesive composition prepared as above was applied onto a peeling-treated surface of a peeling sheet (manufactured by Lintec Corporation, trade name: SP-PET3811) obtained by subjecting one surface of a polyethylene terephthalate film to a peeling treatment with a silicone-based peeling agent such that the thickness after drying became 15 μm, and the composition was heated at an atmospheric temperature of 100° C. for 1 minute, thereby forming a pressure-sensitive adhesive layer. The pressure-sensitive adhesive layer was bonded to a peeling-treated surface of another peeling sheet (manufactured by Lintec Corporation, trade name: SP-PET3801) obtained by subjecting one surface of a polyethylene terephthalate film to a peeling treatment with a silicone-based peeling agent, thereby manufacturing a pressure-sensitive adhesive sheet having peeling sheet/pressure-sensitive adhesive layer/peeling sheet laminated in this order.

TABLE 3

| | Coating liquid | | | | | | | | | |
|---|---|---|---|---|---|---|---|---|---|---|
| | | | Polymer B | | | | | | | |
| | | | | MEK solution | | Concentration | Surface | Liquid | | |
| | | Polymerizable | | viscosity | | of solid | tension | viscosity | | |
| | | compound | | [mPa · | | content | difference | [mPa · s, | Y¹ | Y² |
| Example | Type | [mass ratio] | Type | s, 60° C.] | Type | [% by mass] | [mN/m] | 25° C.] | [mN/m] | [mN/m] |
| Example 1 | A-1 | DPHA/Light | Polymer | 15 | Cyclohexanone | 80 | 1 | 19 | 24.2 | 25.4 |
| | | Ester 2EG | B3 | | MEK | | | | | |
| | | (50/50) | | | | | | | | |
| Example 2 | A-1 | DPHA/Light | Polymer | 15 | Cyclohexanone | 80 | 1 | 19 | 24.2 | 25.4 |
| | | Ester 2EG | B3 | | MEK | | | | | |
| | | (50/50) | | | | | | | | |
| Example 3 | A-1 | DPHA/Light | Polymer | 15 | Cyclohexanone | 80 | 1 | 19 | 24.2 | 25.4 |
| | | Ester 2EG | B3 | | MEK | | | | | |
| | | (50/50) | | | | | | | | |
| Example 4 | A-1 | DPHA/Light | Polymer | 15 | Cyclohexanone | 80 | 1 | 19 | 24.2 | 25.4 |
| | | Ester 2EG | B3 | | MEK | | | | | |
| | | (50/50) | | | | | | | | |
| Comparative | A-1 | DPHA/Light | Polymer | 15 | Cyclohexanone | 80 | 1 | 19 | 24.2 | 25.4 |
| Example 1 | | Ester 2EG | B3 | | MEK | | | | | |
| | | (50/50) | | | | | | | | |
| Example 5 | A-1 | DPHA/Light | Polymer | 15 | Cyclohexanone | 80 | 1 | 19 | 24.2 | 25.4 |
| | | Ester 2EG | B3 | | MEK | | | | | |
| | | (50/50) | | | | | | | | |
| Example 6 | A-1 | DPHA/Light | Polymer | 15 | Cyclohexanone | 60 | 1 | 9 | 24.2 | 25.4 |
| | | Ester 2EG | B3 | | MEK | | | | | |
| | | (50/50) | | | | | | | | |
| Comparative | A-1 | DPHA/Light | Polymer | 15 | Cyclohexanone | 80 | 1 | 19 | 24.2 | 25.4 |
| Example 2 | | Ester 2EG | B3 | | MEK | | | | | |
| | | (50/50) | | | | | | | | |
| Comparative | A-1 | DPHA/Light | Polymer | 15 | Cyclohexanone | 80 | 1 | 19 | 24.2 | 25.4 |
| Example 3 | | Ester 2EG | B3 | | MEK | | | | | |
| | | (50/50) | | | | | | | | |
| Comparative | A-1 | DPHA/Light | Polymer | 15 | Cyclohexanone | 80 | 1 | 19 | 24.2 | 25.4 |
| Example 4 | | Ester 2EG | B3 | | MEK | | | | | |
| | | (50/50) | | | | | | | | |

| | | | | | Drying | | | | | |
|---|---|---|---|---|---|---|---|---|---|---|
| | | | | | Step B | | | Step C | | |
| | | | | | (primary drying) | | | (secondary drying) | | |
| | Coating liquid | | | Coating | Drying | Drying | | Drying | | Evaluation |
| | | t | Coating | amount | time | rate | Temperature | time | Temperature | of surface |
| Example | Y²/Y¹ | [s] | method | [μm] | [g/m²/s] | [g/m²/s] | [° C.] | [g/m²/s] | [° C.] | condition |
| Example 1 | 1.05 | 3 | Wire bar | 34.6 | 6 | 0.02 | 25 | 0.02 | 25 | B |
| Example 2 | 1.05 | 3 | Wire bar | 34.6 | 6 | 0.02 | 25 | 0.2 | 60 | B |
| Example 3 | 1.05 | 3 | Wire bar | 34.6 | 6 | 0.1 | 40 | 0.02 | 25 | B |
| Example 4 | 1.05 | 3 | Wire bar | 34.6 | 20 | 0.1 | 40 | 0.02 | 25 | B |
| Comparative | 1.05 | 3 | Wire bar | 34.6 | 3 | 0.1 | 40 | 0.02 | 25 | C |
| Example 1 | | | | | | | | | | |
| Example 5 | 1.05 | 3 | Wire bar | 34.6 | 6 | 0.1 | 40 | 0.2 | 60 | B |
| Example 6 | 1.05 | 2 | Wire bar | 34.6 | 5 | 0.1 | 40 | 0.2 | 60 | B |
| Comparative | 1.05 | 3 | Wire bar | 34.6 | 6 | 0.2 | 60 | 0.02 | 25 | C |
| Example 2 | | | | | | | | | | |
| Comparative | 1.05 | 3 | Wire bar | 34.6 | 6 | 0.5 | 80 | 0.02 | 25 | D |
| Example 3 | | | | | | | | | | |
| Comparative | 1.05 | 3 | Wire bar | 34.6 | 6 | 0.02 | 25 | 0.5 | 80 | C |
| Example 4 | | | | | | | | | | |

TABLE 4

| | Coating liquid | | | | | | | | | |
|---|---|---|---|---|---|---|---|---|---|---|
| | | | Polymer B | | | | | | | |
| | | | | MEK solution | | Concentration | Surface | Liquid | | |
| | | Polymerizable | | viscosity | | of solid | tension | viscosity | | |
| | | compound | | [mPa · | | content | difference | [mPa · | Y¹ | Y² |
| Example | Type | [mass ratio] | Type | s, 60° C.] | Type | [% by mass] | [mN/m] | s, 25° C.] | [mN/m] | [mN/m] |
| Example 7 | A-2 | DPHA/Light | Polymer | 29 | Cyclohexanone | 80 | 0.8 | 19 | 31.8 | 33.4 |
| | | Ester 2EG | B1 | | MEK | | | | | |
| | | (50/50) | | | | | | | | |
| Example 8 | A-3 | DPHA/Light | Polymer | 39 | Cyclohexanone | 80 | 1 | 19 | 26.1 | 27.4 |
| | | Ester 2EG | B2 | | MEK | | | | | |
| | | (50/50) | | | | | | | | |
| Comparative | A-4 | DPHA/Light | Polymer | 10 | | 80 | 1 | 19 | 24 | 25.2 |
| Example 5 | | Ester 2EG | B4 | | | | | | | |
| | | (50/50) | | | | | | | | |
| Example 9 | A-5 | DPHA/Light | Polymer | 29 | Cyclohexanone | 60 | 0.8 | 16 | 31.5 | 33.1 |
| | | Ester 2EG | B1 | | MEK | | | | | |
| | | (50/50) | | | | | | | | |
| Example 10 | A-6 | DPHA/Light | Polymer | 29 | Cyclohexanone | 80 | 0.8 | 10 | 31.3 | 32.9 |
| | | Ester 2EG | B1 | | MEK | | | | | |
| | | (50/50) | | | | | | | | |
| Comparative | A-8 | DPHA/Light | Polymer | 15 | Cyclohexanone | 50 | 3.9 | 1.9 | 27.7 | 29.1 |
| Example 6 | | Ester 2EG | B3 | | MEK | | | | | |
| | | (50/50) | | | | | | | | |
| Example 11 | A-9 | DPHA/Light | Polymer | 15 | Cyclohexanone | 80 | 1 | 15 | 24.2 | 25.4 |
| | | Ester 2EG | B3 | | MEK | | | | | |
| | | (50/50) | | | | | | | | |
| Example 12 | A-1 | DPHA/Light | Polymer | 15 | Cyclohexanone | 80 | 1 | 19 | 24.2 | 25.4 |
| | | Ester 2EG | B3 | | MEK | | | | | |
| | | (50/50) | | | | | | | | |

| | | | | | Drying | | | | | |
|---|---|---|---|---|---|---|---|---|---|---|
| | | | | | Step B | | | Step C | | |
| | | | | | (primary drying) | | | (secondary drying) | | |
| | Coating liquid | | | Coating | Drying | Drying | | Drying | | Evaluation |
| | | t | Coating | amount | time | rate | Temperature | time | Temperature | of surface |
| Example | Y²/Y¹ | [s] | method | [μm] | [g/m²/s] | [g/m²/s] | [° C.] | [g/m²/s] | [° C.] | condition |
| Example 7 | 1.05 | 3 | Wire bar | 34.6 | 6 | 0.1 | 40 | 0.2 | 60 | A |
| Example 8 | 1.05 | 3 | Wire bar | 34.6 | 6 | 0.1 | 40 | 0.2 | 60 | A |
| Comparative | 1.05 | 3 | Wire bar | 34.6 | 7 | 0.1 | 40 | 0.2 | 60 | C |
| Example 5 | | | | | | | | | | |
| Example 9 | 1.05 | 3 | Wire bar | 45 | 6 | 0.1 | 40 | 0.2 | 60 | A |
| Example 10 | 1.05 | 2 | Wire bar | 34.6 | 5 | 0.1 | 40 | 0.2 | 60 | B |
| Comparative | 1.05 | 2 | Wire bar | 55.4 | 3 | 0.1 | 40 | 0.2 | 60 | D |
| Example 6 | | | | | | | | | | |
| Example 11 | 1.05 | 3 | Wire bar | 34.6 | 6 | 0.02 | 25 | 0.02 | 25 | B |
| Example 12 | 1.05 | 3 | die coater | 34.6 | 6 | 0.1 | 40 | 0.2 | 60 | B |

As shown in Table 3 or 4, it was seen that any of the films obtained by the production methods of Examples were ranked as A or B in the evaluation of surface condition and had excellent surface smoothness.

On the other hand, it can be seen that in Comparative Examples 1 and 6 in which the drying time of the primary drying (step B) was beyond the range of that in the production method of the present disclosure; Comparative Examples 2 and 3 in which the drying rate of the primary drying (step B) was beyond the range of that in the production method of the present disclosure; Comparative Example 4 in which the drying rate of the secondary drying (step C) was beyond the range of that in the production method of the present disclosure; Comparative Example 5 in which the MEK solution viscosity of the specific polymer was beyond the range of that in the production method of the present disclosure; and Comparative Example 5 in which the specific polymer was not used, the surface conditions were deteriorated and thus, the surface smoothness was not obtained.

The disclosure of Japanese Patent Application No. 2017-184896 filed on Sep. 26, 2017 is incorporated herein by reference in its entirety.

All of the documents, patent applications, and technical standards described in the present specification are herein incorporated by reference to the same extent as if each individual document, patent application, and technical standard were specifically and individually indicated to be incorporated by reference.

What is claimed is:

1. A method for producing a film, comprising:
a step A of applying a coating liquid containing a film-forming compound, a polymer, and a solvent onto a support to form a coating film, the polymer being at least one selected from a polymer having a fluoroaliphatic group or a polymer having a siloxane structure, and allowing a solution having the polymer dissolved in methyl ethyl ketone at a solid content of 55% by mass to have a viscosity of 15 mPa·s or more at a liquid temperature of 60° C.;
a step B of drying the coating film formed in the step A at a rate at which the coating film shows a mass change of from 0.02 g/m²/s to 0.1 g/m²/s for a time which is twice or more t seconds satisfying a condition A shown below; and
a step C of drying the coating film after the step B at a rate at which the coating film shows a mass change of from 0.02 g/m²/s to 0.2 g/m²/s:
Condition A: In a case of measuring a dynamic surface tension of the coating liquid at a liquid temperature of 25° C. by a maximum bubble pressure method, γ2/γ1≤1.05 is satisfied, in which a dynamic surface tension at a bubble lifetime of 5 seconds is defined as γ1 and a dynamic surface tension at a bubble lifetime of t seconds which is shorter than 5 seconds is defined as γ2.

2. The method for producing a film according to claim 1,
wherein the coating liquid has a concentration of the solid contents of 60% by mass or more.

3. The method for producing a film according to claim 1,
wherein the step A is a step of applying the coating liquid onto the support such that a film thickness of the coating film becomes 25 μm or more.

4. The method for producing a film according to claim 1,
wherein a value obtained by subtracting a surface tension shown in a case of adjusting a concentration of the solid contents of the coating liquid to 60% by mass from a surface tension shown in a case of adjusting the concentration of the solid contents of the coating liquid to 90% by mass is 1 mN/m or less.

5. The method for producing a film according to claim 1,
wherein the polymer allows a solution having the polymer dissolved in methyl ethyl ketone at a solid content of 55% by mass to have a viscosity from 25 mPa·s to 50 mPa·s at a liquid temperature of 60° C.

6. The method for producing a film according to claim 1,
wherein the support is a continuous support.

7. The method for producing a film according to claim 1,
wherein the polymer includes a polymer having a fluoroaliphatic group.

8. The method for producing a film according to claim 1,
wherein the coating liquid contains a polymerizable compound as the film-forming compound and a polymerization initiator.

9. The method for producing a film according to claim 8, further comprising a step D of irradiating the coating film after the step C with actinic energy rays.
